(19) United States
(12) Patent Application Publication
(10) Pub. No.: US 2021/0166028 A1
(43) Pub. Date: Jun. 3, 2021

(54) AUTOMATED PRODUCT RECOGNITION, ANALYSIS AND MANAGEMENT

(71) Applicant: Petuum Inc., Pittsburgh, PA (US)

(72) Inventors: Sudarshan Ramenahalli Govindaraju, Sunnyvale, CA (US); Min Xu, Pittsburgh, PA (US); Bin Zhao, Sunnyvale, CA (US); Alok Khanna, Mountain View, CA (US); Ni Zhang, Mountain View, CA (US)

(21) Appl. No.: 16/702,268

(22) Filed: Dec. 3, 2019

(51) Int. Cl. G06K 9/00; G06Q 30/06; G06K 9/32

(52) U.S. Cl. CPC G06K 9/00671; G06K 9/325; G06Q 30/0629

(57) ABSTRACT

A computer implemented method for and an apparatus for performing recognizing target product from store shelf comprising receiving a single target object image and a cluttered environment image; extracting features including semantic features from the target object image and the cluttered environment image; and recognizing instances of the target object from the cluttered environment by matching the extracted features of the target object image with the extracted features of the cluttered environment image.

### TECHNICAL FIELD

The present disclosure generally relates to automated product recognition from store shelves based on semantic features and automated product analysis and management based on product recognition data.

### BACKGROUND

Retail store management is traditionally highly laborious and time-consuming. Store managers need to regularly inspect each shelf, for example, to track product sales, out of stock products, nearly out of stock products, slow-moving products that are unnecessarily occupying precious shelf space, and product planogram compliance. Considerable amount of time is also spent on analyzing this information to ensure pleasant customer shopping experience, optimal product placement, and efficient inventory management, and to perform various product sales analysis such as competitive product sales analysis, new product sales analysis, and pilot product launch sales analysis. Therefore, there exists a need to automate retail store management tasks, particularly the automation of the store shelf inspection and analysis, which can provide helpful real-time tracking of product placement and product sales information.

Recently, attempts have been made to use computer vision, deep learning and artificial intelligence to automate store shelf inspection and analysis. However, automation of store management is still difficult due to challenges in automated product recognition using computer vision. Product recognition using computer vision is challenging mainly for the following reasons: (1) shelf image can be highly complex and cluttered; (2) many products look nearly identical except for small differences, for example, two shampoo bottles with the same shape and design are identical to each other except for minor differences in color and/or the texts on the bottles, for example, the text on one bottle may say “normal hair”, while the text on the other bottle may say “dry, damaged hair”; (3) products on the shelves are often partially occluded; and (4) different lighting source in different stores or store locations emit light with different spectral characteristics that leads to shift in perceived color.

Due to these reasons, traditional computer vision techniques based on perceptual features or low-level visual attributes alone often fail because they don't have enough discriminatory power to differentiate products that are similar looking.

### SUMMARY

The present approach leverages computer vision and deep learning to accomplish automated object recognition from cluttered environment and automated object analysis and management, which addresses, at least in part, the above challenges. In one aspect, the object is a product, the cluttered environment is a store shelf or a set of store shelves, and the herein provided techniques enable automated product recognition from store shelf and various automated product analysis and management tasks such as automated shelf space analysis, inventory management, planogram compliance analysis, marketing campaign analysis and enforcement, and check-out free store management, etc.

In one aspect, a system for automated object recognition, analysis and management is provided. When generally described, the system comprises processor, memory coupled to the processor, the memory storing computer instructions which when executed causes the processor to perform a computer implemented method for automated object recognition, analysis and management.

In one aspect, the method for automated object recognition, analysis and management may include performing the steps of 1) receiving an object image and a cluttered environment image; 2) extracting features including semantic features from the object image and the cluttered environment image; 3) recognizing the object from the cluttered environment by matching the extracted features of the object image to those of the cluttered environment image; 4) generating object recognition data for instances of the object recognized in the cluttered environment image; and in one aspect, the method may further include 5) automatically analyzing and managing the object based on the object recognition data.

In one aspect, the method may be applied to recognize, analyze and manage the same or different objects placed in the same or different cluttered environments. In one aspect, object images for different objects and cluttered environment images for different cluttered environments captured at different time and locations may be received and processed to generate object recognition data for analyzing and managing different objects positioned in different cluttered environments.

Semantic features are features (e.g., visual features) that carry semantic meaning to human. Example semantic features include text, logos, barcodes (e.g., UPC code and QR code), registered trademarks, and company tag lines, markers and labels used by regulatory authorities such as safety marks, quality certifications, dietary marks, etc.

Often time, different objects are visually similar and difficult to distinguish based on “low-level” visual attributes or perceptual features alone, and their differences are manifested more at the semantic level. In such cases, semantic features may provide higher distinguishing power compared to perceptual features, which are traditional computer vision features with no separate human cognitive meaning attached. In other words, perceptual features are non-semantic computer vision features. Examples perceptual features include texture, curves, lines, edges, corners, blobs, and interest points. Perceptual features may be 1D, 2D or 3D features and are often fragmented.

Because semantic features may provide higher distinguishing power compared to perceptual features, in some implementations, only a single object image is needed for recognizing instances of the object in a cluttered environment. As such, the method for automated object recognition, analysis and management may include performing the steps of 1) receiving a single object image and a plurality of cluttered environment images; 2) extracting features including semantic features from the single object image and a plurality cluttered environment images; 3) recognizing the object from the cluttered environment by matching the extracted features of the single object image to those of the plurality of cluttered environment images; 4) generating object recognition data for instances of the object recognized in the plurality of cluttered environment images; and in one aspect, the method may further include 5) automatically analyzing and managing the object based on the object recognition data. In some implementations, the target object image may contain other objects or features in addition to the target object or target object features. Therefore in such cases, the above step of extracting features including semantic features from the target object image comprising extracting features including semantic features of the target object from the target object image; and the above step of recognizing instances of the target object from the cluttered environment by matching the extracted features of the target object image with the extracted features of the cluttered environment image comprising recognizing instances of the target object from the cluttered environment by matching the extracted features of the target object with the extracted features of the cluttered environment image.

In one aspect, in addition to semantic features, perceptual features may also be detected and extracted, and recognizing an object from a cluttered environment may further include matching both semantic features and perceptual features of the object image with that of the cluttered environment image.

In one aspect, various semantic and perceptual feature detection and extraction models may be trained or learned to detect and extract features. Example semantic feature detection and extraction models include, but are not limited to, OCR detection and extraction model, logo detection and extraction model, image-based barcode detection and extraction model, safety/quality/dietary marker detection and extraction model. The feature detection and extraction models may be designed, or alternatively trained or learned using private image databases or publicly accessible image databases.

Preferably, the received object images and cluttered environment images should be high-quality images. However, this may not always be the case. Therefore, in some implementations, the method may further comprise preprocessing the received images prior to extracting features to enhance image quality and remove image defects. Image preprocessing may include one or more image preprocessing stages, such as perspective correction, image stabilization, image enhancement, and/or OCR specific super resolution.

In some implementations, the image preprocessing may include an image preprocessing pipeline having a fixed number or fixed set of image preprocessing stages (i.e., blocks or steps), and all received images may go through image preprocessing by each and every one of the set of image preprocessing stages by default. In some implementations, depending on the nature of image degradation, defect, imaging or sensor domain of each use case or application, the number and type of preprocessing stages can be added or deleted as needed to the set of image processing stages.

In some implementations, instead of having all received images each goes through each and every one of a set of or a pool of available image preprocessing stages by default, one or more image processing stages may be selected from the pool of or the set of available image preprocessing stages to be performed for a received image depending on the particular image quality issues or defects of the received image. In other words, not all images go through the same image preprocessing stages, and the number and type of image preprocessing stages a specific received image goes through varies depending on the particular image defect or degradation, imaging or sensor domain of the specific received image. For example, one received image may go through image preprocessing stages 1, 3 and 5, while another received image may go through image preprocessing stages 1, 2, 3 and 4, since they have been determined to have different image defects and need to be corrected or improved applicable image processing stages.

In some implementations, the method may comprise automatically detecting the specific image quality issues and defects of a received image, and automatically selecting one or more image preprocessing stages for image preprocessing depending on the specific image quality issues and defects of the received image. For example, if the image degradation of a received image is detected to exceed a learnt or pre-determined threshold for a specific image preprocessing stage (i.e., block or step), the specific preprocessing stage would be performed on the received image. In some implementations, a policy network (e.g., policy neural network) may be trained to choose n out the N preprocessing blocks (i.e., steps or stages) in such a way that the number of image preprocessing blocks is minimal and the reward for the policy network or neural network is maximal. The reward for the policy network is determined by object recognition accuracy.

In one aspect, the step of recognizing an object from the cluttered environment by matching the extracted features of the object to those of the cluttered environment image may comprise 1) first identifying proposed instances of the object in the cluttered environment image by matching the perceptual features of the object and the perceptual features of the cluttered environment image without matching the semantic features of the object with the semantic features of the cluttered environment image, and 2) for each of the proposed instances of the object, evaluating whether the proposed instance of the object is indeed the object by matching the sematic features of the object to the semantic features of the proposed instance of the object, or by matching semantic features and perceptual features of the object to that of the proposed instance of the object.

In one aspect, evaluating whether a proposed instance of an object is indeed a true instance of the object comprising 1) matching individual types of semantic features of the object to that of the proposed instance of the object individually for each individual type of semantic features, and optionally matching extracted perceptual features of the object to that of proposed instance of the object; 2) generating an individual matching score for each type of semantic features and optionally generating a matching score for the matched perceptual features; 3) generating a combined matching score based on the individual matching scores using an algorithm such as maximum likelihood averaging algorithm, majority voting algorithm, logistic regression algorithm, and weighted combination algorithm, where the combined matching score may be based individual semantic features and individual perceptual features, and 4) evaluating whether the proposed instance of the object is indeed a true instance of the object based on the combined matching score of the proposed instance of the object.

In one aspect, individual types of semantic features may include OCR (e.g., including character, word, sentence, product tagline, product details), logo, UPC, safety/quality/dietary mark. In one aspect, individual types of perceptual features may include color, curves, lines, edges, corners, blobs, interest points or key points, and deep CNN features. The perceptual features may be 1D, 2D, or 3D features, and can be fragmented.

In one aspect, evaluating whether a proposed instance of an object is indeed the object comprising 1) matching OCR (semantic) features of the object to that of the proposed instance of the object and calculating an individual OCR feature matching score for the proposed instance of the object, 2) matching logo (semantic) features of the object to that of the proposed instance of the object and calculating an individual logo feature matching score for the proposed instance of the object, 3) matching UPC (semantic) features of the object to that of the proposed instance of the object and calculating an individual UPC feature matching score for the proposed instance of the object, 4) matching safety/quality/dietary mark (semantic) features of the object to that of the proposed instance of the object and calculating an individual safety/quality/dietary mark feature matching score for the proposed instance of the object, 5) optionally in some implementations matching deep CNN (non-semantic) features of the object to that of the proposed instance of the object and calculating an individual deep CNN feature matching score for the proposed instance of the object, and 6) calculating a combined matching score for the proposed instance of the object based on the individual OCR feature matching score, the individual logo feature matching score, the individual UPC feature matching score, the individual safety/quality/dietary mark, and optionally in some implementations the individual deep CNN feature matching score of the proposed instance of the object.

In one aspect, the step of generating object recognition data may include calculating and outputting object category, object size, object location, object quantity, and time stamp, cluttered environment map annotated with object type, object quantity, object location, time, semantic annotations (e.g., object category, object information, etc.) of the cluttered environment images, etc.

In one aspect, automatically analyzing and managing the object based on the object recognition data may also include automatically performing various automated object analysis and management tasks. For example, when applying the method to automated product recognition, analysis and management, automatically performing various automated object analysis and management tasks may include automatically performing 1) shelf space analysis, such as identifying out of stock products, nearly out of stock products, fast selling products, slow selling products that are unnecessarily taking up precious shelf space, how various factors (e.g., product placement) affect sales performance, 2) inventory management, 3) product planogram generation, 4) planogram compliance monitoring and enforcement, 5) customer shopping behavior tracking and analysis, 6) marketing campaign monitoring, enforcement, formulation and/or adjustment, and/or 7) check-out-free store monitoring, analysis and management.

### BRIEF DESCRIPTION OF THE DRAWINGS

Various embodiments of the present approach will now be presented in the detailed description by way of example, and not by way of limitation, with reference to the accompanying drawings, wherein:

FIG. 1 is a flow diagram of an example method for recognizing a target object from a cluttered environment.

FIG. 2 is a flow diagram of an example method for extracting semantic features and perceptual features from an image.

FIG. 3 is a flow diagram of an example method for image preprocessing.

FIG. 4 is a flow diagram of another example method for recognizing a target object from a cluttered environment.

FIG. 5 is a flow diagram of an example method for using the object recognition data to perform automated object analysis and management.

FIG. 6 is a block diagram of an example system for recognizing a target object from a cluttered environment.

FIG. 7 is a schematic drawing illustrating an example cluttered environment image.

FIG. 8 is a schematic drawing illustrating an example target object image.

### DETAILED DESCRIPTION

For simplicity and illustrative purposes, the principles of the embodiments of the present approach are described by referring mainly to examples thereof. In the following description, numerous specific details are set forth in order to provide a thorough understanding of the embodiments. It is apparent that the embodiments may be practiced without limitation to all the specific details. Also, the elements of the embodiments may be used together in various combinations. The orders of the steps of disclosed processes or methods may be altered, and one or more steps of disclosed processes may be omitted within the scope of the invention.

As used herein, the terms “a” and “an” are intended to denote at least one of a particular element, the term “includes” and its variant mean includes at least, the term “only one” or the term “one only” or the term “a single” means one and only one, the term “or” means and/or unless the context clearly indicates otherwise, the term “based on” means based at least in part on, the terms “an implementation”, “one implementation” and “some implementations” mean at least one implementation. Other definitions, explicit and implicit, may be included below.

Unless specifically stated or otherwise apparent from the following discussion, the actions described herein, such as “processing”, or “preprocessing”, or “computing”, or calculating”, or “determining”, or “presenting”, or “representing”, or “encoding”, or “outputting”, or “extracting”, or “matching”, or “evaluating”, or “monitoring”, or “performing”, or “managing”, or “monitoring”, or “analyzing”, or “managing”, or the like and variant, refer to the action and processes of a computer system, or similar electronic computing device, unless specifically stated or otherwise apparent from the context, that manipulates and transforms data represented as physical (electronic) quantities within the computer system's registers and memories into other data similarly represented as physical quantities within the computer system memories or registers or other such information storage, transmission or display devices.

The present approach also relates to systems or apparatus for performing the operations, processes, or steps described herein. This system or apparatus may be specially constructed for the required purposes, or it may comprise a general-purpose computer, whether an individual computing device or a distributed computing cluster, selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, distributed storage systems, or any type of media suitable for storing electronic instructions, and each coupled to a computer system bus.

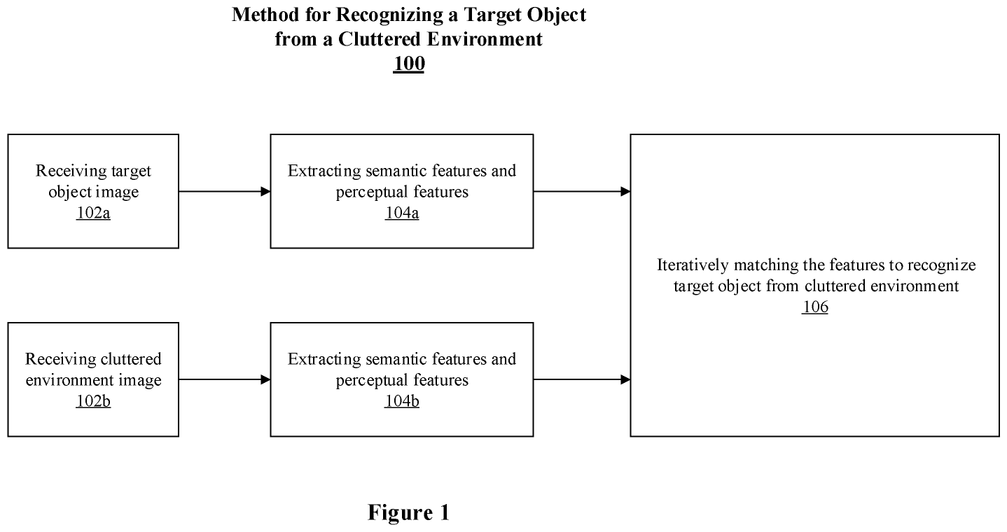

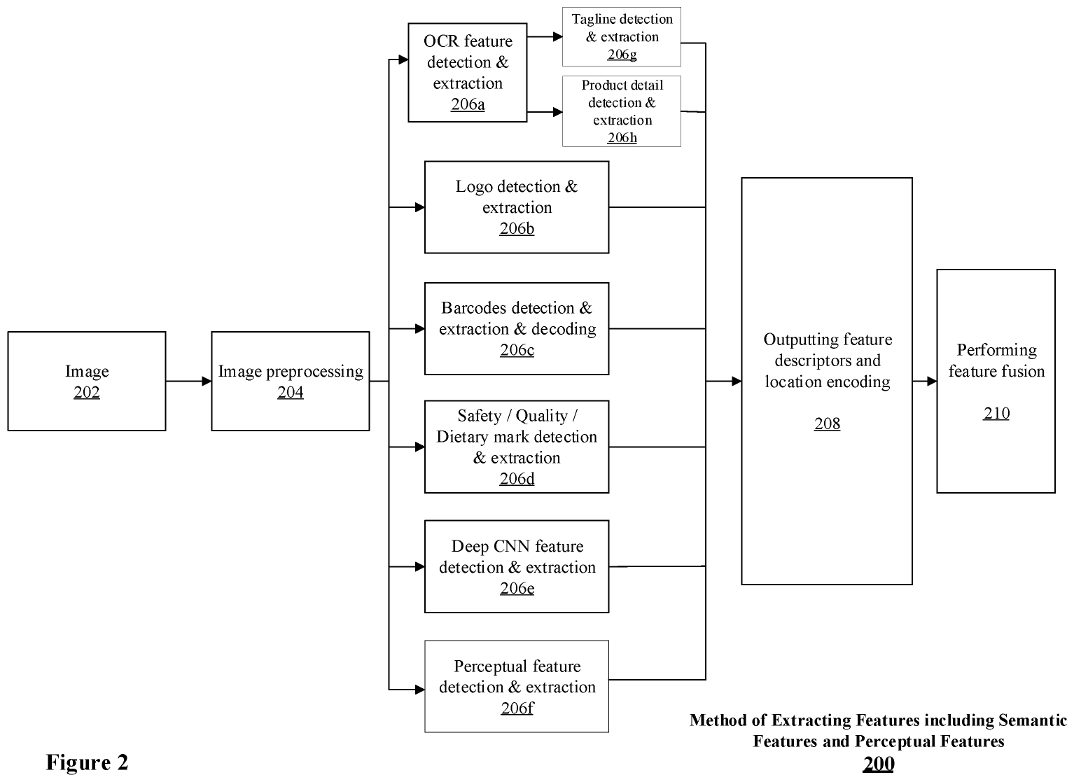

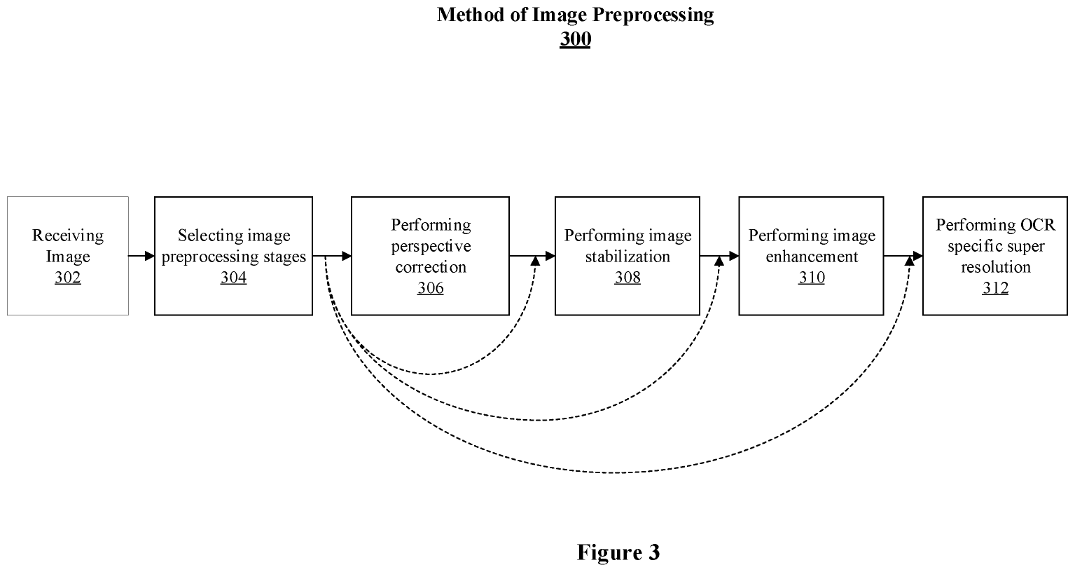

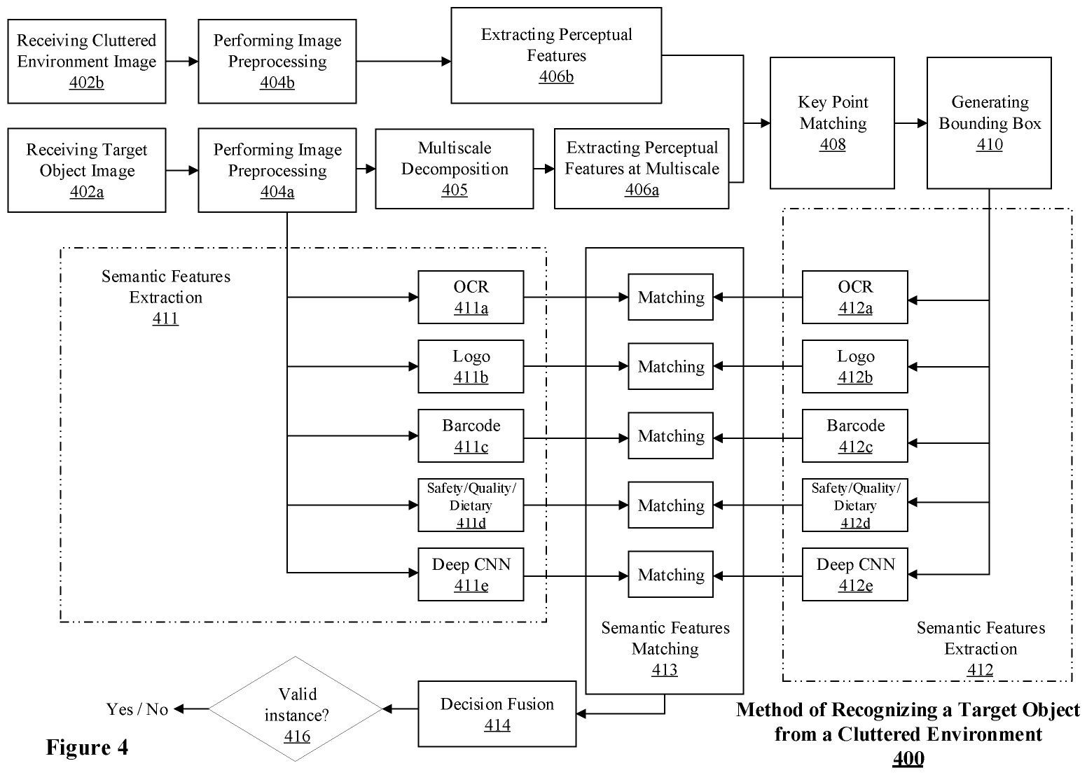

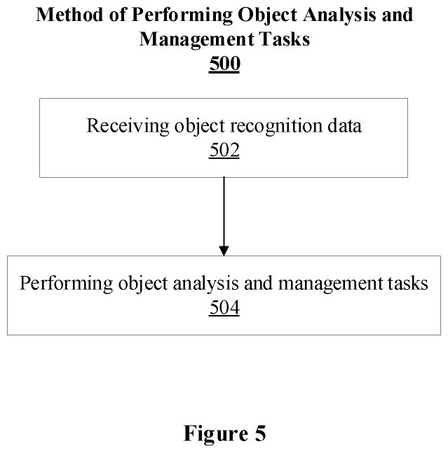

FIGS. 1 to 5 illustrate different components of example methods for automatically recognizing a target object from a cluttered environment for automated object analysis and management. More specifically, FIGS. 1 and 4 illustrate example methods for recognizing a target object from a cluttered environment. FIG. 2 illustrates an example method for extracting features including semantic features and perceptual features from a received image and FIG. 3 illustrates an example method for image preprocessing that can be used in the example methods illustrated in FIGS. 1 and 4. FIG. 5 illustrates an example method for using the object recognition data for automated object analysis and management. The object recognition data may be generated using the example methods as illustrated in FIGS. 1 and 4.

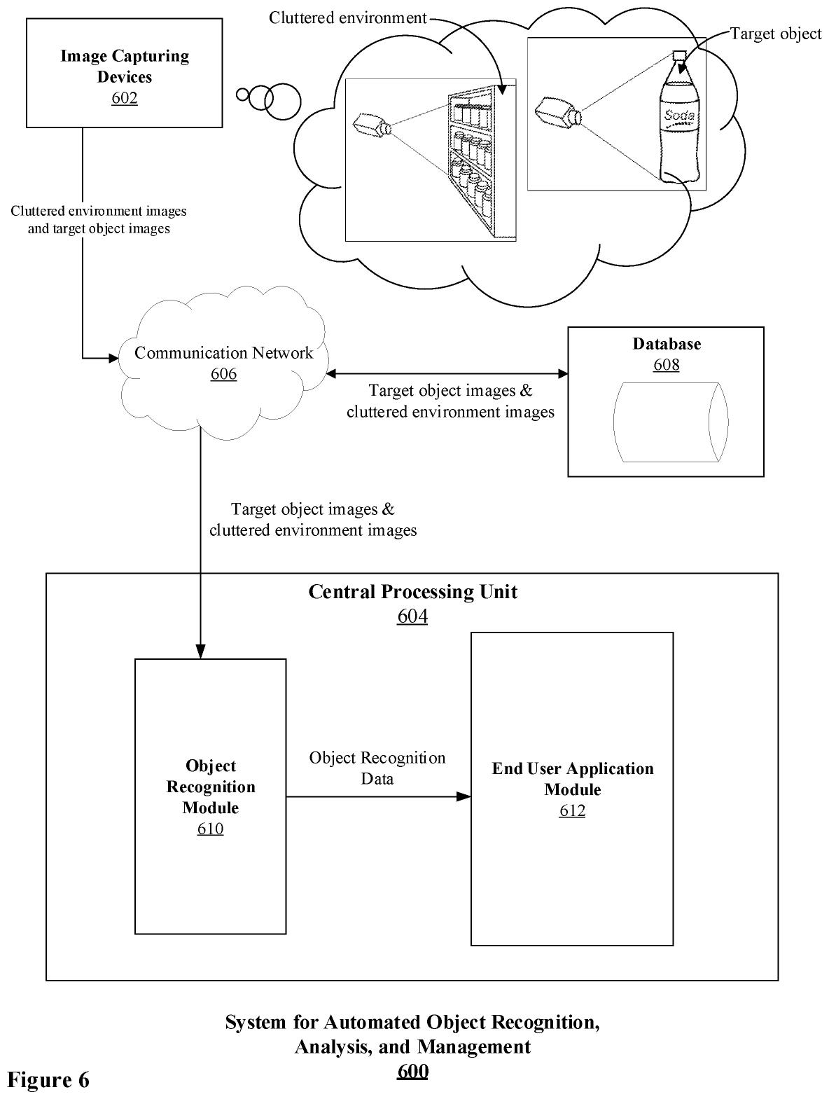

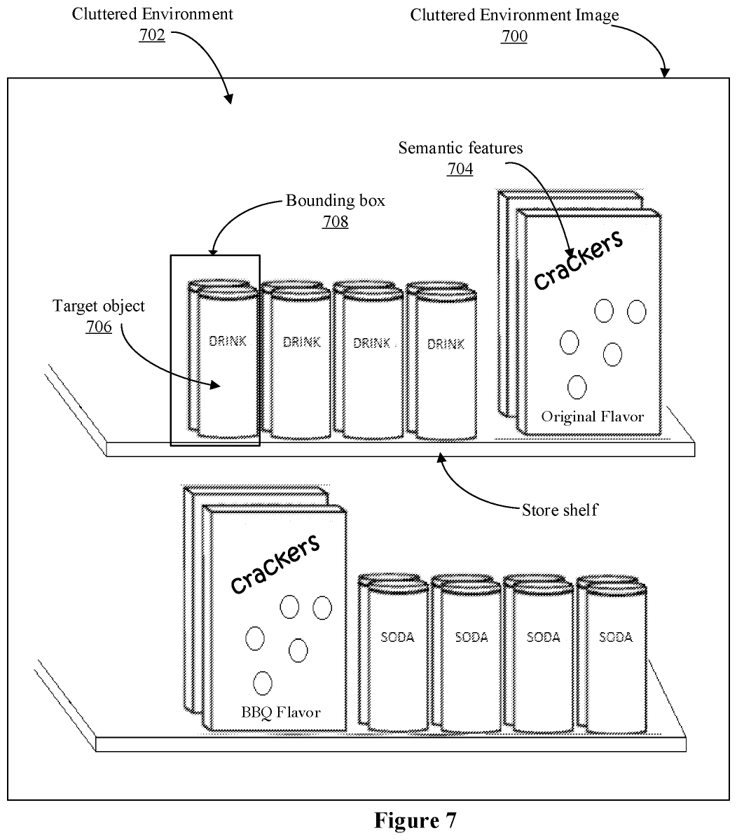

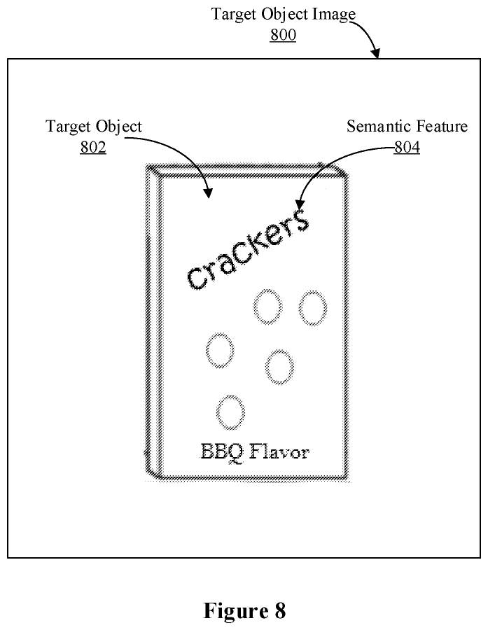

FIG. 6 illustrates an example system for recognizing a target object from a cluttered environment that can be used to implement the methods illustrated in FIGS. 1 to 4. FIG. 7 illustrates an example cluttered environment image and FIG. 8 illustrates an example target object image.

One application of the present approach is automated product recognition, analysis and management in the retail industry. Using this approach, end users may accurately and robustly detect and recognize a specific target product or multitude of target products in highly cluttered store shelves images for a single store shelf or a set of store shelves across an entire store. Connected to image capturing devices that periodically capture still images or real-time videos of shelves, the current approach can be used to automatically recognize specific products and perform various retail analytics and/or management, such as shelf space analysis, product sales analysis, inventory management, planogram compliance management, marketing campaign management, and check-out-free store management, etc.

In addition to the retail industry, the present approach may also be used for automated object recognition, analysis and management in other industries. For example, the current approach may be used for prohibited item recognition, analysis and management at a security check point setting, or for medicine container recognition, analysis and management in a pharmacy setting, or for inventory item recognition, analysis and management in an inventory setting.

FIG. 1 is a flow diagram of an example method 100 for recognizing target object from cluttered environment. In some implementations, a target object is a target product, the cluttered environment is a store shelf pertaining to a store. The method 100 comprises performing the steps of:

At step 102a, receiving a target object image, and at step 102b, receiving a cluttered environment image.

The target object image is preferably a high-resolution digital image with the target object prominently centered. The target object image may be an image provided by client, captured by camera or video camera, or obtained through search of internet or database based on for example target object image, name and/or description, or extracted from an image containing the target object. For example, the target object image may be extracted from a product catalog, or extracted from a product shelf image based on a product planogram. In some implementations, the target object image is a 3D image containing depth information captured using 3D image capturing device(s).

The cluttered environment image is preferably a high-resolution digital image of the cluttered environment. The cluttered environment image may be captured by camera or video camera. Each cluttered environment image may be time stamped and location stamped to indicate the time and location for taking the cluttered environment image. In some implementations, the cluttered environment image is a 3D image containing depth information captured using 3D image capturing device(s).

At step 104a, extracting semantic features and perceptual features from the received target object image, and at step 104b, extracting semantic features and perceptual features from the received cluttered environment image.

Perceptual features are features or visual attributes perceived by visual systems with no separate human cognitive meanings attached. Example perceptual features include curves, lines, edges, corners, blobs, and interest points or key points. The perceptual features may be 1D, 2D, or 3D features. Example perceptual features includes deep CNN features for short such as ImageNet trained deep CNN features.

Semantic features are features that carry semantic meaning to humans. Example semantic features include text, logos, barcodes, registered trademarks, company tag lines, markers and labels used by regulatory authorities such as safety marks, quality certifications, and dietary marks, etc.

Extracting perceptual features may include outputting feature descriptors or feature vectors that encode interesting information into a series of numbers. Feature descriptors or feature vectors can be used to recognize or differentiate one feature from another. In some implementations, the feature descriptors are key point descriptors. Various algorithms may be used to extract perceptual features and outputting feature descriptors, examples of which include SIFT (Scale-Invariant Feature Transform), SURF (Speed Up Robust Features), KAZE and ORB (Oriented Fast and Rotated BRIEF).

Extracting semantic features may include 1) extracting perceptual features of the semantic features, 2) outputting feature descriptors of the semantic features, 3) classifying or assigning the semantic features to appropriate semantic meaningful categories. Each semantic category is assigned semantic meaning. Semantic feature categorization or classification may be single-label classification into mutually exclusive semantic meaningful categories, or multi-label classification where each semantic feature may be classified or categorized into multiple semantic categories. Semantic classification or categorization may also be hierarchical.

An example method 200 for extracting features, including both semantic features and perceptual features, from a received image is explained in more details below in reference to FIG. 2. In some implementations, the received images may be preprocessed on an as-needed basis prior to feature extraction to improve image quality and remove image defects. An example method 300 for preprocessing images is explained in more details below in reference to FIG. 3.

Returning to FIG. 1, at step 106, iteratively matching the feature descriptors of the semantic features and perceptual features extracted from the target object image to that of the cluttered environment image, to recognize the target object from the cluttered environment.

Iteratively matching the feature descriptors of the target object to that of the cluttered environment image may be achieved by performing the steps of: 1) masking out the matched key points matched at the first N_k iterations and the corresponding feature descriptors from the cluttered environment image, 2) matching the remaining feature descriptors of the cluttered environment image and corresponding key points at the (k+1)^{th} iteration with that of the target object until the minimum_number_of matching_points (Mₘᵢₙ) are found in the cluttered environment image per iteration or repeating cycle. The iterative matching terminates when the number of the matched key points falls below the predefined minimum_number_of_matching points (Mₘᵢₙ) threshold. Matching metrics may be calculated and outputted for feature matching, and an instance of the target object is considered recognized in the cluttered environment image if the matching metrics meet predefined criteria.

The matching of feature descriptors may be performed using any suitable matching method or algorithm, for example, approximate nearest neighbor search, CODE (Reference 1), RepMatch (Reference 2), GMS (Reference 3), or any other graph-based matching algorithm that supports deformable matching (Reference 4) or tree-matching-technique may be used.

Recognizing instances of the target object from a cluttered environment image may include outputting target object recognition data for each instance of the target object recognized in the clutter environment image. The target object recognition data for an instance of the target object recognized may include, but are not limited to, target object information (e.g., object identification, category, description), location, segmentation information (e.g., bounding box enclosing the object), size, orientation, and time stamp for that instance of the target object.

In some implementations, the target object image may contain other objects or features in addition to the target object or target object features. Therefore in such cases, the above step 104a of extracting semantic features and perceptual features from the target object image comprising extracting semantic features and perceptual features of the target object only from the target object image, and the above step 106 iteratively matching the feature descriptors of the semantic features and perceptual features extracted from the target object image to that of the cluttered environment image, to recognize the target object from the cluttered environment comprising iteratively matching the feature descriptors of the semantic features and perceptual features of the target object only extracted from the target object image to that of the cluttered environment image, to recognize the target object from the cluttered environment.

FIG. 2 is a flow diagram of an example method 200 for extracting features including semantic features and perceptual features from a received image. The method comprises performing the steps of:

At step 202, receiving an image. The received image may be a target object image or a cluttered environment image.

At step 204, preprocessing the received image. Depending on the particular image quality issues and/or defects, the received image may or may not need to be preprocessed. Therefore, in some implementations, image preprocessing is performed on an as-needed basis. An example method for preprocessing images is further explained in detail in reference to FIG. 3.

At step 206a-206h, detecting and extracting semantic features and optionally detecting and extracting perceptual features from the received image, which comprises performing the following steps:

At steps 206a-206d and 206g, 206h, detecting and extracting semantic features from the received image using various trained semantic feature detection and extraction model(s). A single semantic detection and extraction model may be trained to detect and extract one type of semantic features. Different semantic feature detection and extraction models may be trained to detect and extract different types of semantic features. The various semantic feature detection and extraction models may be trained using client provided images and/or publicly available images (e.g., ImageNet). The training images may or may not contain the target object image. In this example, detecting and extracting semantic features may include the following steps:

At step 206a, using OCR detection and extraction model to detect and extract characters from the received image. The OCR detection and extraction model may be a Deep CNN model trained to perform character detection and recognition and fine-tuned using any images that contain printed or written characters, not specific to retail shelf images. The OCR detection and extraction model may be trained using publicly available generic data such as image data obtained from the internet (e.g., images from ImageNet), no domain/customer specific data for training OCR detection and extraction model is needed. In this example, the OCR detection and extraction model records the width and height of each character to perform character detection and recognition in the wild, at character, word and sentence level. The OCR detection and extraction model supports multi-lingual character detection and recognition and is capable of detecting characters in any orientation, color, font type, and size. The OCR detection and extraction model takes the received image and outputs characters, words, and sentences and corresponding descriptors. The detected characters may be represented in Unicode character set, and words are represented using bag-of-words or similar NLP schemes such as word2vec methods.

At step 206g, from the outputted characters, words, and sentences of the OCR detection and extraction model, a tagline detection and extraction model searches for specific product taglines (e.g., slogans) stored in a product tagline database, assign tagline identity and tagline associated product information (e.g., product manufacturer). Product tagline or slogan is a catchphrase or small group of words that are combined in a special way to identify a product or company. Example product taglines include “Melts in Your Mouth, Not in Your Hands” for M&M, “There are some things money can't buy. For everything else, there's MasterCard” for MasterCard, “A Diamond is Forever” for De Beers, and “Just Do It” for Nike.

At step 206h, from the outputted characters, words, and sentences of the OCR detection and extraction model, a product detail detection and extraction model extracts product details. Product details define detailed parameters of products. Example product details may include, for example for shampoo, for men, for women, bottle size (e.g., 16 oz), for damaged hair, for normal hair, for oily hair, contains vitamin E, contains protein, etc.

The extracted product details may be matched with or assigned to loosely defined super-categories of target objects or products (e.g., any men's shampoo, women's shampoo, 16 oz sized shampoo, shampoo for oily hair, shampoo for normal hair, and shampoo for damaged hair, etc., —will be assigned to the super-category Hair Care Products) stored in a database (e.g., product details database). This allows for the selection of right type of image classification model later, used during the deep CNN model's extraction of features for matching purpose. In some implementations, one or more CNN neural network-based image classification models may be trained or fine-tuned for each of the super-categories. Since the number of super-categories are designed to be small, only a few models will need to be trained. Moreover, the super-categories are loosely defined. Examples of super-categories are Vegetables, Meat, Hair Care, Cereals, Canned Foods, Dairy, Bakery, etc., which should not exceed 5-15 depending on the size of the store and diversity of the products (or objects). By training models for smaller subset of product categories, we expect the CNN features to have better discriminative power. Publicly available retail image databases can be used for training these models and does not require customer-specific data. Even if the product catalog keeps changing, since we are using these models only for super-category specific feature extraction and not actual classification, data availability is not going to be a bottleneck.

At step 206b, using logo detection and extraction model to detect and extract product logos from the received image, annotate or assign logo identity and/or logo associated product information.

Logo contains some partial information about the target object. In cases the target object is a product, logo may contain or be associated with product information, such as product brand, product category, product distributor, product manufacturer, etc., that is useful and important for accurate object recognition. The logo detection and extraction model may be trained using publicly available images of product logos found for example on the internet.

At step 206c, using image-based barcode detection and extraction model to detect and extract barcodes, such as UPC codes and QR codes, from the received image, annotating or assigning barcode identity and/or associated product information.

The detected barcodes are preprocessed to remove any slant/tilt if needed and are decoded to further output barcode descriptors and annotate or assign barcode identities and associated product information. Barcodes contain machine-readable information such as exact categorization of the associated object (e.g., product) and therefore are helpful in accurate object recognition. UPC (Universal Product Code) is a type of barcode used worldwide in recognizing and identifying products. Detecting UPC codes may allow for the exact categorization of the target objects (e.g., target products). QR code is a two-dimensional barcode containing more information of the associated object than UPC code, which may be helpful in accurate object recognition.

At step 206d, using marker detection and extraction model to detect and extract markers and labels used by regulatory authorities such as safety marks, quality certifications, and dietary marks from the received image, and output marker descriptors and annotate or assign marker identity and associated product information. A deep CNN based marker detection and extraction model may be trained using marker containing images such as images found in publicly available databases or the internet. Special markers such as safety marks, quality marks, certification, registered trademarks, labels, and dietary marks may serve as distinguishing features between similarly packaged products and therefore may be crucial for accurate object recognition. For example, the discernable difference between two products of the same product line may be a dietary mark, a safety mark, or a quality mark or certification. For example, the discernable difference between a vegan cake versus an egg or dairy containing cake may be a green dot, a dietary mark indicating it's a vegan product.

At 206e, optionally in some implementations using Deep CNN (Convolutional Neural Networks) model to detect and extract perceptual features from the received image. The Deep CNN model is trained using the standard image classification found on ImageNet, such as VGG16 model. The ImageNet trained Deep CNN model may be capable of detecting and extracting features from penultimate layer, and the extracted features are then used for matching based on cosine distance. The ImageNet trained Deep CNN models are capable of discriminating small feature differences among objects.

At step 206f, optionally in some implementations, using the trained perceptual feature detection and extraction model to detect and extract perceptual features from the received image and output corresponding feature descriptors. The perceptual feature detection and extraction model may be trained using client provided image(s) and/or publicly available images. The training images may or may not contain the target object image. The training images may be annotated images. In some implementations, the trained models are traditional computer vision feature models such as SIFT (Scale Invariant Feature Transform), SURF (Speeded Up Robust Features), KAZE, and ORB (Oriented FAST and Rotated BRIEF) models.

At step 208, encoding difference types of perceptual and semantic features in a common space reference frame.

Feature descriptors contain various spatial relationship information of the extracted features and with respect to their surrounding features. The feature descriptors further convey important information of the extracted feature, such as a unique combination of its location, angles, distances, and/or shapes with respect to other surrounding features.

Encoding different types of perceptual and semantic features may comprise representing or encoding the features (e.g., key points) and their spatial relationships in a common space reference frame.

The method for representing or encoding spatial relationships among the extracted features may vary, depending on the type of the extracted feature. In some implementations, the spatial relationships may be represented or encoded based on the angle of each feature with respect to a common axis (e.g., X-axis), or based on the distance of each feature to a common point (usually origin).

In some implementations, the spatial relationships may be represented or encoded based on the direction and distance of one feature with respect to another. In some implementations, the spatial relationships may be represented or encoded based on the distance ratios and the internal angles among the features. Furthermore, the spatial relationships may be represented in different forms including matrix, multiple matrices and multi-dimensional tensors for each type of independent measurement, such as distance, angle, ratio, etc. The spatial relationships may also be represented or encoded in a graph with the vertices representing the features and the links representing the spatial relationships among the features. In one example, the common reference frame may be the left-top of the image, and the spatial relationships of feature key points may be represented or encoded based on the feature vector and angle with respect to the X-axis.

At step 210, performing feature fusion of the feature descriptors by combining the feature descriptors outputted by the individual semantic and perceptual feature detection and extraction models. In this example, feature fusion comprises combining the outputted feature descriptors by the OCR detection and extraction model, logo detection and extraction model, image-based barcode detection and extraction model, marker detection and extraction model, ImageNet trained Deep CNN model, and perceptual feature detection and extraction model. Combining feature descriptors includes integrating the individual feature descriptors into a common spatial frame and calculating spatial relationship of the individual features in the common spatial frame.

FIG. 3 is a flow diagram of an example method 300 for image preprocessing. The method comprises performing the steps of:

At step 302, receiving an image. The received image may be a target object image or a cluttered environment image.

At step 304, detecting image quality issues and defects, and selecting the image preprocessing stages based on the detected image quality issues and defects.

The received image may have different image qualities and defects such as captured with different view perspectives, scales, lighting, and/or resolution. For example, images captured by moving photographers may have higher level of blurriness compared to images captured by stationary cameras. Varied lighting exposure during capture may cause the images to appear brighter or darker. Distance between the camera and the captured object may affect image sharpness and image clarity. Placement of the object and its location with respect to its resting platform and nearby objects may cause the object to appear rotated, slanted, partially occluded, or partially visible in the image. Image preprocessing serves to improve image qualities, remove image defects and/or normalize the received images.

Depending on the particular image quality issues and defects of the receive image, image preprocessing may comprise selecting to perform one or more image preprocessing stages, which are designed to address a specific type of image degradation or defect observed images, which may for example include perspective correction, image stabilization, image enhancement, and OCR specific super resolution. Automatic selection of image preprocessing stages efficiently addresses the particular image quality issues and defects of each received image on an as-needed basis.

Automated methods may be designed and used to quantify and determine if a particular degradation or defect is present in a received image or not. For example, to quantify the amount of blur in an image to determine whether there is image blurriness defect, we may look at the local power distribution in wavelet domain. Or in a different approach, we may use existing no-reference image quality metrics such as Structural Similarity Index (SSIM) or develop custom quality metrics for each degradation or defect type. Specific methods and corresponding thresholds for a particular image degradation or defect may be determined based on one or more image degradation models or learned from image data.

Selection of image preprocessing stages can be fixed based on a predefined rule or controlled by a policy network (e.g., policy neural network) or model or any other suitable method.

In some implementations, the image preprocessing may include an image preprocessing pipeline having a fixed number of image preprocessing blocks (i.e., steps or stages), and a received image may go through image preprocessing by each and every one of the image preprocessing blocks by default. Depending on the nature of image degradation, defect, imaging or sensor domain, the number and type of preprocessing blocks can be added or deleted as needed. In some implementations, the method may comprise automatically selecting one or more image preprocessing stages for image preprocessing depending on the specific image quality issues and defects of the received images. In some implementations, automatic detection of image degradation type or image defect type may be employed. For example, if the image degradation of a received image exceeds a learnt or pre-determined threshold for a specific image preprocessing block (i.e., step or stage), specific preprocessing block would be performed on the received image. In some implementations, a policy network (e.g., policy neural network) may be trained to choose n out the N preprocessing blocks (i.e., steps or stages) in such a way that the number of image preprocessing blocks is minimal and the reward for the policy network or neural network is maximal. The reward for the policy network is determined by object recognition accuracy. In this example, performing image preprocessing may include performing none, one or more of the following image preprocessing stages:

At step 306, performing perspective correction on the received image. Perspective correction serves to remove the slant and tilt and minimize the number of vanishing points in the received image. To perform perspective correction, image is rotated in 3D space iteratively until such minimum number of vanishing points is observed.

Depending on the placement of the objects when the image is captured, the objects may be slanted or tilted with respect to the fronto-parallel plane on which the received image is captured, thus causing features in the received images to be compressed, creating vanishing points, and causing parallel lines to no longer appear parallel. Removing the slant and tilt removes feature compression, minimizes vanishing points (e.g., ideally to zero) and allows parallel lines to remain parallel.

At step 308, performing image stabilization on the received image. Motion during image capturing may cause blurriness of the objects contained in the received image. Different methods of image capturing may cause different levels of blurriness. For example, images captured by moving photographer may have greater blurriness than images captured by robotic platform or stationary platform. Image stabilization enhances accuracy of feature extraction and target object recognition by removing blurriness which can be particularly important to text-based feature recognition, since text has higher susceptibility to blurriness due to its fewer pixels. In some implementations, image stabilization may be achieved with the state-of-the-art technique disclosed in “Scale-recurrent Network for Deep Image Deblurring” (Reference 5) or may be replaced by any other suitable techniques available.

At step 310, performing image enhancement on the received image to improve image brightness, clarity, and sharpness to render the received images more feasible for subsequent stages of processing.

At step 312, performing OCR specific super resolution on the received image, which may further enhance specifically OCR feature or text-based recognition from the cluttered environment. Deep CNN models trained on blurry character images and corresponding high-resolution character images may be used to perform OCR specific super resolution.

Although different image preprocessing stages appear in a successive order as depicted in FIG. 3, the different image preprocessing stages may occur in other orders, such as in parallel or in a reversed successive order. In addition to the above image preprocessing stages discussed in reference to FIG. 3, other types of image preprocessing stages such as image sub-sampling, rotations, etc. may be performed.

FIG. 4 is a flow diagram showing an alternative example method 400 for recognizing a target object from a cluttered environment. The method comprises performing the steps of:

At step 402a, receiving a target object image, and at step 402b, receiving a cluttered environment image. In some implementations, the target object is a target product, the cluttered environment image is an image of a store shelf or a set of store shelves in a store.

At step 404a, preprocessing the received target object image on an as-needed basis, and at step 404b, preprocessing the received cluttered environment image on an as-needed basis. An example method for preprocessing images is further explained in detail in reference to FIG. 3.

At step 406b, detecting and extracting perceptual features from the cluttered environment image. An example method 200 for detecting and extracting features including semantic features and perceptual features is explained in detail in reference to FIG. 2.

At step 405, performing multiple-scale decomposition on the target object image. In some implementations, performing multiple-scale decomposition is only carried out on the target object image and not on the cluttered environment image.

At step 406a, detecting and extracting perceptual features from the target object image at multiple scales. In some implementations, multiple-scale perceptual feature extraction is only carried out for target object images and not for cluttered environment images. An example method for detecting and extracting perceptual features are illustrated in reference to FIG. 2. Multiple-scale feature extraction serves to account for fixed sized of the kernels used in feature descriptors. Perceptual features may be computed at automatically detected key points as well as regularly spaced grid at multiple scales. In some implementations, the multiple-scale decomposition method comprises of detecting and extracting perceptual features at multiple scales, saving the features detected and extracted at down-sampling level for later use, and translating back to native image resolution from the smaller scales.

Detecting and extracting perceptual features may further comprise outputting feature descriptors, an example of which is explained in detail in reference to FIG. 2. The perceptual feature descriptors of the target object image may be detected and outputted at multiple scales based on one or a combination of sampling locations, such as the local maxima and minima, the strongest locations, the most prominent locations in the images, regular uniformly sampled locations, regularly spaced and drift locations, etc. In some implementations, only the perceptual feature descriptors of the target object image, and not that of the cluttered environment image, are detected and outputted at multiple scales.

At step 408, performing key point matching of the perceptual feature descriptors of the received target object image to the perceptual feature descriptors of the cluttered environment image to identify proposed instances of the target object in the cluttered environment image. In some implementations, key point matching may be achieved by iteratively matching the descriptors of the extracted perceptual features, an example of which is explained in detail in reference to FIG. 1.

At step 410, generating a bounding box to segment each of the identified proposed instances of the target object in the cluttered environment image. Generating the bounding box in the cluttered environment image may comprise performing the steps of:
1. Computing the ratio of the distance between two matched key points on the target object to the target object image's width and height. This ratio may be identical to the ratio of the distance between the corresponding matched key points in the cluttered environment image to the bounding box's width and height.
2. Calculating the height of the bounding box using the following equation:

$$( \frac{image height}{ordinate distance of 2 matched keypoints} ) of target object = ( \frac{plausible bounding box height}{\begin{matrix}ordinate distance of \\ corresponding matched keypoints\end{matrix}} ) of cluttered environment \qquad Equation 1$$

3. Calculating the width of the bounding box using the following equation:

$$( \frac{image width}{ordinate distance of 2 matched keypoints} ) of target object = ( \frac{plausible bounding box width}{\begin{matrix}ordinate distance of \\ corresponding matched keypoints\end{matrix}} ) of cluttered environment \qquad Equation 2$$

4. Upon deriving the height and the width of the bounding box, calculating the top-left point of the bounding box on the cluttered environment image based on translating one random key point with respect to the origin in the target object image;
5. Generating one or more bounding boxes for all matched key points in the target object by repeating the above steps.

In some implementations, bounding box may also be generated using RANSAC homography method. Although both methods may be used to generate bounding box, the method of step 410 in FIG. 4 may be more accurate than RANSAC homography method. When matching two similar looking objects, RANSAC homography method generates a large number of false positive key point matches due to matching lighting conditions and matching orientations, rather than due to true similarity between the matched objects.

At step 411, detecting and extracting semantic features from the target object image, an example of which is explained in detail above in reference to FIG. 2. Detecting and extracting semantic features from the target object image does not require the prior performance of generating bounding box described at step 410. In some implementations, detecting and extracting semantic features from the target object image may occur directly succeeding the performance of image preprocessing described at step 404a.

At step 412, detecting and extracting semantic features from the generated bounding box, if proposed instance of target object has been identified on the cluttered environment image. An example method for detecting and extracting semantic features is explained in detail above in reference to FIG. 2.

At step 413, for each semantic feature type, matching the feature descriptors of the target object image for that semantic feature type to that of the clutter environment image within each bounding box, and outputting an individual matching score for that semantic feature type. An example method for performing iterative feature matching is explained in detail in reference to FIG. 1. In some implementations, the outputted individual matching scores for each semantic feature type may be normalized, for example to a [0,1] range.

At step 414, for each generated bounding box, calculating a combined matching score for that bounding box based on the individual matching scores outputted by performing step 413, and determining whether the proposed instance of target object is indeed the target object based on the combined matching score. In some implementations, the combined matching score for a bounding box may be a binary decision corresponding to whether the bounding box is valid or not.

The combined matching score may be calculated using suitable methods such as maximum likelihood averaging, majority voting, logistic regression, weighted combination, or any other suitable algorithm.

At step 416, determining whether the proposed instances of target object segmented by the bounding box is indeed the target object based on the combined matching score. In some implementations, if the binary decision is associated with yes, then output yes to indicate the proposed instances of target object segmented by the bounding box is indeed the target object; if the binary decision is associated with no, then output no to indicate the proposed instances of target object segmented by the bounding box is not the target object.

In some implementations, the target object image may contain other objects or features in addition to the target object or target object features. Therefore in such cases, 1) the above step 406a of detecting and extracting perceptual features from the target object image at multiple scales comprising detecting and extracting perceptual features of the target object only from the target object image at multiple scales; 2) the above step 408 of performing key point matching of the perceptual feature descriptors of the received target object image to the perceptual feature descriptors of the cluttered environment image to identify proposed instances of the target object in the cluttered environment image comprising performing key point matching of the perceptual feature descriptors of only the received target object extracted from the target object image to the perceptual feature descriptors of the cluttered environment image to identify proposed instances of the target object in the cluttered environment image; 3) the above step 411 of detecting and extracting semantic features from the target object image comprising detecting and extracting semantic features of only the target object extracted from the target object image; and 4) the above step 413 of for each semantic feature type, matching the feature descriptors of the target object image for that semantic feature type to that of the clutter environment image within each bounding box, and outputting an individual matching score for that semantic feature type comprising for each semantic feature type, matching the feature descriptors of only the target object extracted from the target object image for that semantic feature type to that of the clutter environment image within each bounding box, and outputting an individual matching score for that semantic feature type.

FIG. 5 illustrates an example method 500 for using the object recognition data for automated object analysis and management, the method 500 comprising:

At step 502, receiving object recognition data. The object recognition data may be generated by a system (e.g., system 600) for automated object recognition, analysis and management implementing methods for automated object recognition, analysis and management illustrated in detail in reference to FIGS. 1 to 5. The object recognition data may include cluttered environment images (e.g., product shelf images) annotated with recognized target objects identity, type, placement location, quantity, and time stamp, etc.

At step 504, performing one or more object analysis and management tasks using the received object recognition data (e.g., various automated product analysis and management tasks), examples of which include 1) automated shelf space analysis, such as identifying out of stock products, nearly out of stock products, slow selling products that are unnecessarily taking up precious shelf space; 2) assessing product stocking status; 3) analyzing product sales information; 4) automatically generating product planogram; 5) planogram compliance monitoring and enforcement; 6) customer shopping behavior tracking and analysis; 7) product marketing campaign monitoring, enforcement, formulation and/or adjustment; 8) check-out-free store monitoring, analysis and management; 9) various product sales analysis such as competitive product sales analysis, new product sales analysis, and pilot product launch sales analysis, etc.

FIG. 6 illustrates an example system 600 for recognizing a target object from a cluttered environment. The system 600 comprises image capturing devices 602, a central processing unit 604, communication network 606, and database 608. The central processing unit 604 may include an object recognition module 610 and end-user application module 612 which includes various end-user applications for performing various automated object analysis and management tasks. In some implementations, the end-user application module 612 may include inventory management application for managing inventory, planogram compliance application for monitoring and enforcing planogram compliance, and marketing strategic planning application for marketing campaign planning, monitoring and enforcement.

The image capturing devices 602 may include one or more image capturing devices. The image capturing devices may be camera or video camera, may be configured to capture time-sequenced images, time stamp captured images, and capture image depth information. The image capturing devices 602 may be used to capture and transmit cluttered environment images and target object images.

The central processing unit 604 may be configured to receive cluttered environment images and target environment images from the image capturing devices 602 and/or database 608 through the communication network 606, preprocess the target object images and the cluttered environment images to recognize instances of the target objects in the cluttered environment image, and output object recognition data by for example implementing methods illustrated in reference to FIGS. 1 to 5.

The communication network 606 may comprise wired or wireless network, it may comprise cellular network, virtual private network (VPN), wide area network (WAN), global area network, internet, and/or any other suitable network.

The database 608 may comprise private database and/or publicly available database. The database 608 may store target object images and/or cluttered environment images.

The object recognition module 610 may include processors, memory for storing instructions, which when executed by the processors cause the processors to perform a method for automated object recognition, analysis and management, and examples of which are illustrated in reference to FIGS. 1 to 5. The object recognition module 610 receives the target object images and the cluttered environment images from the image capturing devices 602 and/or database 608, performs image preprocessing, detects and extracts semantic and perceptual features from the target object images and the cluttered environment images, recognizes instances of target objects from the cluttered environment images, and outputs target object recognition data.

The end user application module 612 receives the target object recognition data from the object recognition module 610 and performs various automated object analysis and management tasks such as 1) shelf space analysis, such as identifying out of stock products, nearly out of stock products, fast selling products, slow selling products that are unnecessarily taking up precious shelf space, how various factors (e.g., product placement) affect sales performance, 2) inventory management, 3) automated product planogram generation, 4) planogram compliance monitoring and enforcement, 5) customer shopping behavior tracking and analysis, 6) marketing campaign monitoring, enforcement, formulation, and/or adjustment, and/or 7) check-out-free store monitoring, analysis and management.

FIG. 7 is a schematic drawing illustrating an example cluttered environment image 700 of a cluttered environment 702. The cluttered environment image 700 includes a plurality of target objects 706 having semantic features 704. FIG. 7 also shows an example bounding box 708 around an instance of recognized target object. In this particular example, the cluttered environment image 700 is a cluttered shelf image of a store, the example target product 706 is a store product, the example semantic feature 704 is a product logo.

FIG. 8 is a schematic drawing illustrating an example target object image 800. In the example shown, the target object 802 is a store product, the semantic feature 804 is a product logo.

### REFERENCE CITED

1. Lin, W. Y., Wang, F., Cheng, M. M., Yeung, S. K., Torr, P. H., Do, M. N., & Lu, J. (2017). Code: Coherence based decision boundaries for feature correspondence. IEEE transactions on pattern analysis and machine intelligence, 40(1), 34-47.
2. Lin, W. Y., Liu, S., Jiang, N., Do, M. N., Tan, P., & Lu, J. (2016, October). Repmatch: Robust feature matching and pose for reconstructing modern cities. In European Conference on Computer Vision (pp. 562-579). Springer, Cham.
3. Bian, J., Lin, W. Y., Matsushita, Y., Yeung, S. K., Nguyen, T. D., & Cheng, M. M. (2017). Gms: Grid-based motion statistics for fast, ultra-robust feature correspondence. In Proceedings of the IEEE Conference on Computer Vision and Pattern Recognition (pp. 4181-4190).
4. Zhou, F., & De la Torre, F. (2013). Deformable graph matching. In Proceedings of the IEEE Conference on Computer Vision and Pattern Recognition (pp. 2922-2929).
5. Tao, X., Gao, H., Shen, X., Wang, J., & Jia, J. (2018). Scale-recurrent network for deep image deblurring. In Proceedings of the IEEE Conference on Computer Vision and Pattern Recognition (pp. 8174-8182).

What is claimed is:

1. A computer implemented method for recognizing a target object from a cluttered environment, wherein the target object is a target product and the cluttered environment comprising a store shelf, the computer implemented method comprising:
Receiving a target object image and a cluttered environment image;
Extracting features including semantic features from the target object image and the cluttered environment image; and
Recognizing instances of the target object from the cluttered environment by matching the extracted features of the target object image with the extracted features of the cluttered environment image.

2. The method of claim 1,
Wherein recognizing instances of the target object from the cluttered environment comprising matching the extracted features of a single target object image with extracted features of the cluttered environment image.

3. The method of claim 1,
Wherein receiving a target object and a cluttered environment image comprising receiving a single target object image and a plurality of cluttered environment images; and
Wherein recognizing instances of the target object from the cluttered environment comprising matching the extracted features of the single target object with the extracted features of the plurality of cluttered environment images.

4. The method of claim 3, wherein the plurality of cluttered environment images comprising a time series images of the cluttered environment.

5. The method of claim 1, further comprising generating object recognition data for recognizing the instances of the target object in the cluttered environment image.

6. The method of claim 1, wherein extracting semantic features comprising extracting feature descriptors of the semantic features and assigning semantic categories to the extracted semantic features.

7. The method of claim 1, wherein the semantic features comprising semantic features selected from the group consisting of: tagline, product details, logo, barcode, UPC symbol, QR code, trademark, service mark, community mark, safety mark, quality mark, dietary mark, and certification.

8. The method of claim 1, wherein extracting features further comprising extracting perceptual features from the target object image and the cluttered environment image.

9. The method of claim 1, further comprising for a received image, selecting image preprocessing stages based on detected image quality issues of the received image, and performing the selected image processing stages on the received image.

10. The method of claim 1, further comprising identifying proposed instances of target object in the cluttered environment image by matching the perceptual features of the target object image with the perceptual features of the cluttered environment image; and
If a proposed instance of target object is identified from the cluttered environment image, evaluating whether the proposed instance of target object is the target object by matching the extracted semantic features of the target object image with the extracted semantic features of the proposed instances of the target object.

11. An apparatus for recognizing a target object from a cluttered environment, the computer implemented method comprising a memory, and a processor coupled to the memory and configured to perform the steps of:
Receiving a target object image and a cluttered environment image;
Extracting features including semantic features from the target object image and the cluttered environment image; and
Recognizing instances of the target object from the cluttered environment by matching the extracted features of the target object image with the extracted features of the cluttered environment image.

12. The apparatus of claim 11,
Wherein recognizing instances of the target object from the cluttered environment comprising matching the extracted features of a single target object image with extracted features of the cluttered environment image.

13. The apparatus of claim 11,
Wherein receiving a target object and a cluttered environment image comprising receiving a single target object image and a plurality of cluttered environment images; and
Wherein recognizing instances of the target object from the cluttered environment comprising matching the extracted features of the single target object with the extracted features of the plurality of cluttered environment images.

14. The apparatus of claim 13, wherein the plurality of cluttered environment images comprising a time series images of the cluttered environment.

15. The apparatus of claim 11, wherein the processor is further comprised to perform the step of:
generating object recognition data for recognizing the instances of the target object in the cluttered environment image.

16. The apparatus of claim 11, wherein extracting semantic features comprising extracting feature descriptors of the semantic features and assigning semantic categories to the extracted semantic features.

17. The apparatus of claim 11, wherein the semantic features comprising semantic features selected from the group consisting of: tagline, product details, logo, barcode, UPC symbol, QR code, trademark, service mark, community mark, safety mark, quality mark, dietary mark, and certification.

18. The apparatus of claim 11, wherein extracting features further comprising extracting perceptual features from the target object image and the cluttered environment image.

19. The apparatus of claim 11, wherein the processor is further configured to perform the step of:
for a received image, selecting image preprocessing stages based on detected image quality issues of the received image, and performing the selected image processing stages on the received image.

20. The apparatus of claim 11, wherein the processor is further configured to perform:
Identifying proposed instances of target object in the cluttered environment image by matching the perceptual features of the target object image with the perceptual features of the cluttered environment image; and
If a proposed instance of target object is identified from the cluttered environment image, evaluating whether the proposed instance of target object is the target object by matching the extracted semantic features of the target object image with the extracted semantic features of the proposed instances of the target object.
